(19) United States
(12) Patent Application Publication
(10) Pub. No.: US 2009/0315883 A1
(43) Pub. Date: Dec. 24, 2009

(54) AUTOSTEREOSCOPIC DISPLAY WITH PIXELATED LUMINAIRE

(75) Inventor: Vincent W. King, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/142,264

(22) Filed: Jun. 19, 2008

(51) Int. Cl. G06T 15/00

(52) U.S. Cl. 345/419

(57) ABSTRACT

An autostereoscopic display is described. The autostereoscopic display apparatus includes a pixelated backlight having a plurality of vertical pixel stripes. Each pixel stripe includes a left view light source and a right view light source. An image display panel is configured to display a plurality of image stripes that are in registration with the backlight plurality of vertical pixel stripes. A lens array is between the pixelated backlight and the image display panel. The lens array is formed of a plurality of lens stripes. Each lens stripe includes a right view lens and left view lens, and the backlight plurality of vertical pixel stripes are in registration with the plurality of lens stripes. Light from the left view light source is directed through an image stripe and to a left view position through the left view lens and light from the right view light source is directed through an image stripe and to a right view position through the right view lens.

### FIELD

The present disclosure relates to autostereoscopic displays that include a pixelated luminaire.

### BACKGROUND

A stereoscopic display usually presents an observer with images with parallax from individual right and left eye viewpoints. There are two methods of providing the two eyes of the observer with the parallax images. In one method, the observer utilizes a pair of shutter or 3D glasses which transmit or block light from the viewer's eyes in synchronization with alternating the left/right image display. Similarly, in another method, right eye and left eye viewpoints are alternatively displayed and led to the respective eyes of the observer but without the use of 3D glasses. This second method is referred to as autostereoscopic and is desired for stereo 3D viewing because separate glasses are not needed.

A liquid crystal display (LCD) is a sample and hold display device such that the image at any point or pixel of the display is stable until that pixel is updated at the next image refresh time, typically 1/60 of a second or faster. In such a sample and hold system, displaying different images, specifically displaying alternating left and right images for an autostereoscopic display, requires careful timing sequencing of the light sources so that, for example, the left eye image light source is not on during the display of data for the right eye and vice versa.

Ensuring that the right and left light sources are on or off in synchronization with the image display is important to achieve a high quality autostereoscopic image. However, since the images are temporally multiplexed, one eye sees black data half the viewing time, a “flicker” is often created and causes a viewer discomfort. Elimination of flicker in an autostereoscopic display is desired, especially in displays that operate at a 60 hertz or less refresh rate.

### BRIEF SUMMARY

The present disclosure relates to autostereoscopic displays that includes a pixelated luminaire.

In one exemplary embodiment, the autostereoscopic display apparatus includes a pixelated backlight having a plurality of vertical pixel stripes. Each pixel stripe includes a left view light source and a right view light source. An image display panel is configured to display a plurality of image stripes that are in registration with the backlight plurality of vertical pixel stripes. A lens array is between the pixelated backlight and the image display panel. The lens array is formed of a plurality of lens stripes. Each lens stripe includes a right view lens and left view lens, and the backlight plurality of vertical pixel stripes are in registration with the plurality of lens stripes. Light from the left view light source is directed through an image stripe and to a left view position through the left view lens and light from the right view light source is directed through an image stripe and to a right view position through the right view lens.

In another exemplary embodiment, a method of displaying autostereoscopic images includes illuminating a liquid crystal display panel with a pixelated backlight having a plurality of vertical pixel stripes. Each pixel stripe includes a left view light source and a right view light source. Then, displaying a first half of a right view image with the right light source and a first half of a left view image with the left view light source simultaneously as alternating image stripes on the liquid crystal display panel. The image stripes are registered with the pixel stripes, and the right view image is directed toward a viewer right eye and the left view image is directed toward the viewer left eye. Then displaying a second half of a right view image with the right light source and a second half of a left view image with the left view light source simultaneously as alternating image stripes on the liquid crystal display panel. The image stripes are registered with the pixel stripes, and the right view image is directed toward a viewer right eye and the left view image is directed toward the viewer left eye, forming a 3D image.

In another exemplary embodiment, an autostereoscopic display apparatus includes a pixelated backlight having a plurality of vertical pixel stripes. Each pixel stripe includes a left view light source and a right view light source. An image display panel is configured to display a plurality of image stripes that are in registration with the backlight plurality of vertical pixel stripes. A lens array is between the pixelated backlight and the image display panel. The lens array is formed of a plurality of lens stripes. Each lens stripe includes a right view lens and left view lens, and the backlight plurality of vertical pixel stripes are in registration with the plurality of lens stripes. Light from the left view light source is directed through an image stripe and to a left view position through the left view lens and light from the right view light source is directed through an image stripe and to a right view position through the right view lens. The image display panel is configured to simultaneous display right view images and left view images forming a 3D image.

### BRIEF DESCRIPTION OF THE DRAWINGS

The disclosure may be more completely understood in consideration of the following detailed description of various embodiments of the invention in connection with the accompanying drawings, in which:

FIG. 1 is a schematic front view of an illustrative display apparatus;

FIG. 2 is a schematic cross-sectional diagram view of the exemplary display shown in FIG. 1;

FIG. 3 is a schematic diagram of a spatial multiplex scheme for the exemplary apparatus shown in FIG. 1; and

FIG. 4A and FIG. 4B are schematic cross-sectional diagram views of the illustrative display apparatus of FIG. 1 in operation.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “autostereoscopic” refers to displaying three-dimensional images that can be viewed without the use of special headgear or glasses on the part of the user or viewer. These methods produce depth perception in the viewer even though the image is produced by a flat device.

A liquid crystal display is a sample and hold display device such that the image at any particular point is stable until that point or pixel is updated at the next image refresh time, typically within 1/50 (or 1/60) of a second or faster. In such a sample and hold system, displaying different images, specifically alternating left and right images for a 3D display, during sequential refresh periods of the display requires careful sequencing of the backlight light sources so that, for example, the left eye light source is not on during the display of data for the right eye and vice versa.

The present disclosure relates to autostereoscopic displays that include a pixelated luminaire. The display includes a pixelated luminaire providing light to an optical lens array to generate directional light toward either a viewer right eye or left eye. Each display frame consists of two fields. The first field consists of alternate strips from the left and right images of the source frame, and the second field consists of alternate strips from the remaining left and right images from the source frame. Half the pixels are directed to the right eye and the other half are directed to the left eye, at the same time. Although in each field, each eye sees only half the number of pixels making up the source image, by the next field, the other half of the image is presented, thus the combined fields provides the eye with full resolution of the source image and there is no sense of flicker. The present disclosure is particularly useful for autostereoscopic displays. The present disclosure is also useful for 3D still image displays. The present disclosure is also useful for 2D image displays where the right and left image fields are the same or similar. While the present disclosure is not so limited, an appreciation of various aspects of the disclosure will be gained through a discussion of the examples provided below.

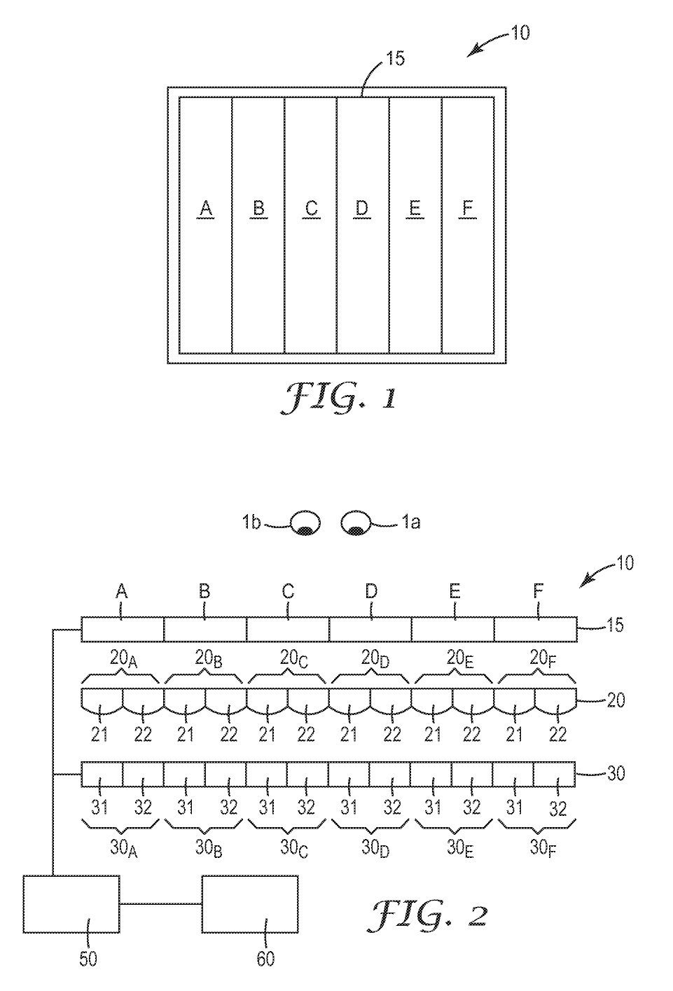

FIG. 1 is a schematic front view of an illustrative display apparatus 10. The display apparatus 10 includes an image display panel 15. The image display panel 15 is configured to display a plurality of vertical image stripes A, B, C, D, E, F (also referred to herein as vertical pixel stripes A, B, C, D, E, F). While six vertical image stripes are illustrated throughout this disclosure, it is understood that the image display panel 15 can includes any useful number of image stripes such as, for example, 10 or more, 50 or more, 100 or more, or 1000 or more. The display apparatus 10 can have any useful shape or configuration. In many embodiments, the display apparatus 10 has a square or rectangular shape.

The image display panel 15 can be any useful display. In many embodiments, the image display panel 15 is a liquid crystal display panel having a refresh rate of 120 hertz or less, or 90 hertz or less, or 60 hertz or less. In some embodiments, the image display panel 15 is a ferroelectric display panel. In many embodiments, each image stripe A, B, C, D, E, F or vertical pixel stripes A, B, C, D, E, F of the image display panel 15 includes two or more colored pixels such as, for example, a red pixel, a green pixel, and a blue pixel.

The image display panel 15 can display a right view image and a left view image at the same time. As described in more detail below, a first half of the right view image and a first half of the left view image are displayed simultaneously as alternate image stripes on the image display panel 15. Then, a second half of the right view image and a second half of the left view image are displayed simultaneously as alternate image stripes on the image display panel 15.

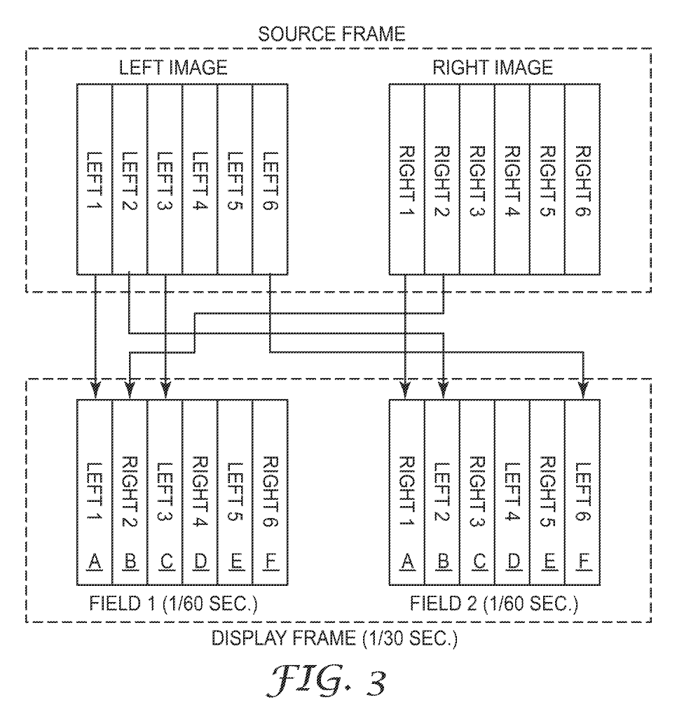

FIG. 2 is a schematic cross-sectional diagram view of the exemplary display 10 shown in FIG. 1. The display apparatus 10 includes an image display panel 15 having the plurality of vertical image stripes A, B, C, D, E, F, described above (i.e., columns of pixels). A pixelated backlight 30 is positioned to provide light to the liquid crystal display panel 15. A lens array 20 is optically between the image display panel 15 and the pixelated backlight 30.

The vertical image stripes A, B, C, D, E, F or column of pixels A, B, C, D, E, F can include red, blue and green colored pixels arranged in any useful configuration. In many embodiments, the vertical image stripes A, B, C, D, E, F or column of pixels A, B, C, D, E, F include red, blue and green colored pixels arranged vertically along the vertical image stripes A, B, C, D, E, F or column of pixels A, B, C, D, E, F. The colored pixels can be arranged as horizontal (orthogonal to the vertical pixel columns) pixel lines of a single color.

The pixelated backlight 30 includes a plurality of vertical pixel stripes 30_{A}, 30_{B}, 30_{C}, 30_{D}, 30_{E}, 30_{F}. In many embodiments, the vertical pixel stripes are in registration with the vertical image stripes. Each vertical pixel stripe 30_{A}, 30_{B}, 30_{C}, 30_{D}, 30_{E}, 30_{F} includes a right view light source 32 and a left view light source 31. In many embodiments the right view light source 32 and a left view light source 31 are solid state light sources. The solid state light sources can be any useful solid state light source that can be modulated at any useful rate such as, for example, 90 hertz or less, 60 hertz or less or 50 hertz or less. In many embodiments, the solid state light source is a plurality of light emitting diodes. In other embodiments, the solid state light source is a plurality of laser diodes or organic light emitting diodes (i.e., OLEDs). The solid state light sources can emit any number of visible light wavelengths such as white, red, blue, and/or green.

The lens array 20 includes a plurality of vertical lens stripes 20_{A}, 20_{B}, 20_{C}, 20_{D}, 20_{E}, In many embodiments, the vertical lens stripes are in registration with the vertical image stripes and the vertical pixel stripes. Each vertical lens stripes 20_{A}, 20_{B}, 20_{C}, 20_{D}, 20_{E}, 20_{F} includes a right view lens 22 and a left view lens 21. The right view lens 22 transmits light from the right view light source 32 and directs it through the image display panel 15 to a viewer right eye 1b. The left view lens 21 transmits light from the left view light source 31 and directs it through the image display panel 15 to a viewer left eye 1a. In many embodiments, the right view lens 22 and a left view lens 21 have a lenticular cross-sectional profile. While the lens array 20 is illustrated as having two separate lenses, it is understood that the right view lens 22 and a left view lens 21 can be a single lens having a compound shape, or having facets, sufficient to direct light as described above.

During operation, light from the pixelated backlight 30 transmits through the lens array 20 and illuminates the image display panel 15. For example, image stripe A displays a portion of a right view image with light provided by the right view light source 32 of pixel stripe 30_{A} and right image lens 22 of lens stripe 20_{A}. Then image stripe A displays a portion of a left view image with light provided by the left view light source 31 of pixel stripe 30_{A and left image lens 21 of lens stripe 20}_{A}. Thus, during operation only one of the left view light source 31 or right view light source 32 of each pixel stripe provides light to the image stripe via the lens stripe.

A synchronization driving element 50 is electrically connected to the pixelated backlight 30 light sources 31, 32 and the image display panel 15. The synchronization driving element 50 synchronizes activation and deactivation (i.e., modulation) of the right eye image solid state light source 32 and the left eye image solid state light source 31 as image frames are provided at a rate of 90 frames per second or less or 60 frames per second or less to the image display panel 15 to produce a flicker-free still image sequence, video stream or rendered computer graphics. An image (e.g., video or computer rendered graphics) source 60 is connected to the synchronization driving element 50 and provides the images frames (e.g., right view images and left view images) to the image display panel 15.

The image source 60 can be any useful image source capable of providing images frames (e.g., first image view and left image views) such as, for example, a video source or a computer rendered graphic source. In many embodiments, the video source can provide image frames from 24 frames per second to 30 frames per second or greater. In many embodiments, the computer rendered graphic source can provide image frames from 50 to 60 Hertz (frames per second) or greater.

The computer rendered graphic source can provide gaming content, medical imaging content, computer aided design content, and the like. The computer rendered graphic source can include a graphics processing unit such as, for example, an Nvidia FX5200 graphics card, a Nvidia GeForce 9750 GTX graphics card or, for mobile solutions such as laptop computers, an Nvidia GeForce GO 7900 GS graphics card. The computer rendered graphic source can also incorporate appropriate stereo driver software such as, for example, OpenGL, DirectX, or Nvidia proprietary 3D stereo drivers.

The video source can provide video content. The video source can include a graphics processing unit such as, for example, an Nvidia Quadro FX1400 graphics card. The video source can also incorporate appropriate stereo driver software such as, for example, OpenGL, DirectX, or Nvidia proprietary 3D stereo drivers.

The synchronization driving element 50 can include any useful driving element providing synchronizing activation and deactivation (i.e., modulation) of the right eye image solid state light source 32 and the left eye image solid state light source 31 with image frames provided to the image display panel 15 to produce a flicker-free 3D video or rendered 3D computer graphics. The synchronization driving element 50 can include a video interface such as, for example, a Westar VP-7 video adaptor (Westar Display Technologies, Inc., St. Charles, Mo.) coupled to custom solid state light source drive electronics.

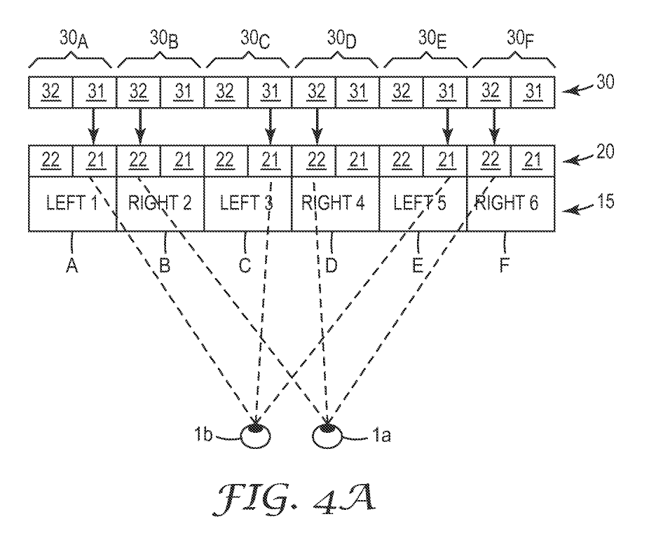

FIG. 3 is a schematic diagram of a spatial multiplex scheme for the exemplary apparatus shown in FIG. 1. A source frame includes a left image field and a right image field (e.g., two fields=1 frame, Left Image Field+Right Image Field). Each right and left image is divided into vertical stripes that correspond to the number of vertical image stripes (e.g., pixel columns)of the display panel. Thus, the illustrated left and right images are divided into six image stripes (A, B, C, D, E, F) to correspond to the display apparatus 10 shown in FIG. 1. The display apparatus displays field 1 for any useful amount of time such as, for example, 1/60 sec (or 1/50 sec) and then modulates to field 2 for any useful amount of time such as, for example, 1/60 sec (or 1/50 sec). It is understood that the display apparatus would include an image buffer module and time delay module.

Field 1 displays half of the left image left 1, left 3, left 5 displayed in image stripes A, C, and E respectively, and Field 1 also displays half of the right image right 2, right 4, right 6 displayed in image stripes B, D, and F respectively. Then Field 2 displays the remaining half of the left image left 2, left 4, left 6 displayed in image stripes B, D, and F respectively, and Field 2 also displays half of the right image right 1, right 3, right 5 displayed in image stripes A, C, and E respectively. Thus, each image stripes (A, B, C, D, E, F) alternates between displaying a portion of a right view image and a left view image. In addition the image stripes (A, B, C, D, E, F) interlace the right and left images across the display.

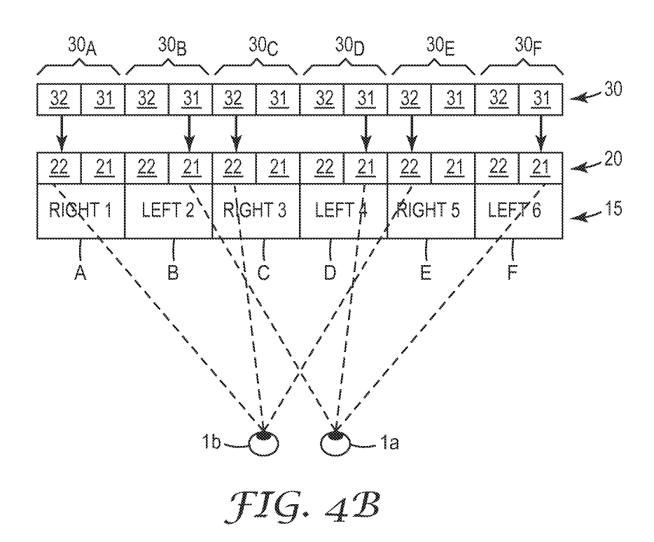

FIG. 4A and FIG. 4B are schematic cross-sectional views of the illustrative display apparatus of FIG. 1 in operation. FIG. 4A illustrates the operation of the display apparatus displaying field 1 of FIG. 3. FIG. 4B illustrates the operation of the display apparatus displaying field 2 of FIG. 3. FIG. 4A and FIG. 4B illustrate how the 3D image is formed by displaying a portion of the left image and a portion of the right image at the same time and then displaying the remaining portion of the left image and the remaining portion of the right image at the same time. FIG. 4A and FIG. 4B together provide a viewer with a 3D image of a source frame that is composed of a left (view) image and a right (view) image as described in connection with FIG. 3.

FIG. 4A illustrates the display apparatus displaying the left 1, left 3, left 5 image portion to the viewer left eye 1b at the same time displaying the right 2, right 4, right 6 image portion to the viewer right eye 1a. The display time of each field can be any useful duration such as, for example, 1/50 of a second, or 1/60 sec.

The left 1 image is displayed on the A image stripe and is illuminated by the left light source 31 of the 30A vertical pixel stripe. The light is directed to the viewer left eye 1b by the left view lens 21 of the vertical lens stripe 20A. The left 3 image is displayed on the C image stripe and illuminated by the left light source 31 of the 30C vertical pixel stripe. The light is directed to the viewer left eye 1b by the left view lens 21 of the vertical lens stripe 20C. The left 5 image is displayed on the E image stripe and is illuminated by the left light source 31 of the 30E vertical pixel stripe. The light is directed to the viewer left eye 1b by the left view lens 21 of the vertical lens stripe 20E. The left 1, left 3, left 5 image portion is displayed at the same time to the viewer left eye 1b.

The right 2 image is displayed on the B image stripe and is illuminated by the right light source 32 of the 30B vertical pixel stripe. The light is directed to the viewer right eye 1a by the right view lens 22 of the vertical lens stripe 20B. The right 4 image is displayed on the D image stripe and illuminated by the right light source 32 of the 30D vertical pixel stripe. The light is directed to the viewer right eye 1a by the right view lens 22 of the vertical lens stripe 20D. The right 6 image is displayed on the F image stripe and is illuminated by the right light source 32 of the 30F vertical pixel stripe. The light is directed to the viewer right eye 1a by the right view lens 22 of the vertical lens stripe 20F. The right 2, right 4, right 6 image portion is displayed at the same time to the viewer right eye 1a.

FIG. 4B illustrates the display apparatus displaying the left 2, left 4, left 6 image portion to the viewer left eye 1b at the same time displaying the right 1, right 3, right 5 image portion to the viewer right eye 1a. The display time of each field can be any useful duration such as, for example, 1/60 of a second.

The left 2 image is displayed on the B image stripe and is illuminated by the left light source 31 of the 30B vertical pixel stripe. The light is directed to the viewer left eye 1b by the left view lens 21 of the vertical lens stripe 20B. The left 4 image is displayed on the D image stripe and illuminated by the left light source 31 of the 30D vertical pixel stripe. The light is directed to the viewer left eye 1b by the left view lens 21 of the vertical lens stripe 20D. The left 6 image is displayed on the F image stripe and is illuminated by the left light source 31 of the 30F vertical pixel stripe. The light is directed to the viewer left eye 1b by the left view lens 21 of the vertical lens stripe 20F. The left 2, left 4, left 6 image portion is displayed at the same time to the viewer left eye 1b.

The right 1 image is displayed on the A image stripe and is illuminated by the right light source 32 of the 30A vertical pixel stripe. The light is directed to the viewer right eye 1a by the right view lens 22 of the vertical lens stripe 20A. The right 3 image is displayed on the C image stripe and illuminated by the right light source 32 of the 30C vertical pixel stripe. The light is directed to the viewer right eye 1a by the right view lens 22 of the vertical lens stripe 20C. The right 5 image is displayed on the E image stripe and is illuminated by the right light source 32 of the 30E vertical pixel stripe. The light is directed to the viewer right eye 1a by the right view lens 22 of the vertical lens stripe 20E. The right 1, right 3, right 5 image portion is displayed at the same time to the viewer right eye 1a.

Although in each field (i.e., field 1 and field 2) each eye sees only half the number of pixels making up the source image, by the next field, the other half of the image is presented, thus the combined fields provides the eye with full resolution of the source image. Thus a viewer does not perceive a “flicker” in the 3D image display even when the source images are provided to the image display panel at a rate of 30 frames per second. A display panel having a refresh rate of 90 hertz or less or 60 hertz can therefore display flicker-free autostereoscopic 3D images.

Thus, embodiments of the AUTOSTEREOSCOPIC DISPLAY PIXELATED LUMINAIRE are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. An autostereoscopic display apparatus comprising:
a pixelated backlight having a plurality of vertical pixel stripes, each pixel stripe includes a left view light source and a right view light source;
an image display panel, the image display panel configured to display a plurality of image stripes being in registration with the backlight plurality of vertical pixel stripes; and
a lens array between the pixelated backlight and the image display panel, the lens array formed of a plurality of lens stripes, each lens stripe comprising a right view lens and left view lens, and the backlight plurality of vertical pixel stripes are in registration with the plurality of lens stripes;
wherein, light from the left view light source is directed through an image stripe and to a left view position through the left view lens and light from the right view light source is directed through an image stripe and to a right view position through the right view lens.

2. An autostereoscopic display apparatus according to claim 1, wherein the image display panel is configured to simultaneous display right view images and left view images forming a 3D image.

3. An autostereoscopic display apparatus according to claim 1, wherein the image display panel is a liquid crystal display panel.

4. An autostereoscopic display apparatus according to claim 1, wherein each image stripe includes a red pixel, green pixel and blue pixel.

5. An autostereoscopic display apparatus according to claim 1, wherein the right view lens and left view lens are lenticular.

6. An autostereoscopic display apparatus according to claim 1, wherein the left view light source and a right view light source comprise solid state light sources.

7. An autostereoscopic display apparatus according to claim 1, wherein the image display panel is configured to simultaneous display alternating right view images and left view images in the pixel stripes, forming a 3D image.

8. An autostereoscopic display apparatus according to claim 1, wherein the image display panel has a refresh rate of 90 hertz or less.

9. A method of displaying autostereoscopic images comprising:
illuminating a liquid crystal display panel with a pixelated backlight having a plurality of vertical pixel stripes, each pixel stripe formed of a left view light source and a right view light source;
displaying a first half of a right view image with the right light source and a first half of a left view image with the left view light source simultaneously as alternating image stripes on the liquid crystal display panel, the image stripes registered with the pixel stripes, and the right view image directed toward a viewer right eye and the left view image directed toward the viewer left eye; and
displaying a second half of a right view image with the right light source and a second half of a left view image with the left view light source simultaneously as alternating image stripes on the liquid crystal display panel, the image stripes registered with the pixel stripes, and the right view image directed toward a viewer right eye and the left view image directed toward the viewer left eye, forming a 3D image.

10. A method according to claim 9, wherein the displaying a first half of a right view image with the right light source and a first half of a left view image with the left view light sources occurs for 1/50 second or less.

11. A method according to claim 9, wherein the displaying a second half of a right view image with the right light source and a second half of a left view image with the left view light sources occurs for 1/50 second or less.

12. A method according to claim 9, wherein light from the left view light source is directed through an image stripe and to the viewer left eye through the left view lens and light from the right view light source is directed through an image stripe and to the viewer right eye through the right view lens.

13. A method according to claim 9, wherein each image stripe alternates between displaying a right view image and left view image.

14. A method according to claim 8, wherein each left view light source is registered with a left view lens and each right view light source is registered with a right view lens.

15. A method according to claim 8, wherein the left view light source and a right view light source comprise solid state light sources.

16. A method according to claim 8, wherein each image stripe includes a red pixel, green pixel and blue pixel.

17. A method according to claim 8, wherein the displaying a first half of a right view image with the right light source and a first half of a left view image with the left view light sources occurs for 1/50 second, and the displaying a second half of a right view image with the right light source and a second half of a left view image with the left view light sources occurs for 1/50 second.

18. A method according to claim 8, wherein the liquid crystal display panel has a refresh rate of 60 hertz or less.

19. An autostereoscopic display apparatus comprising:
a pixelated backlight having a plurality of vertical pixel stripes, each pixel stripe includes a left view light source and a right view light source;
an image display panel, the image display panel configured to display a plurality of image stripes being in registration with the backlight plurality of vertical pixel stripes; and
a lens array between the pixelated backlight and the image display panel, the lens array formed of a plurality of lens stripes, each lens stripe comprising a right view lens and left view lens, and the backlight plurality of vertical pixel stripes are in registration with the plurality of lens stripes;
wherein, light from the left view light source is directed through an image stripe and to a left view position through the left view lens and light from the right view light source is directed through an image stripe and to a right view position through the right view lens and the image display panel is configured to simultaneous display right view images and left view images forming a 3D image.

20. An autostereoscopic display apparatus according to claim 19, wherein the image display panel is configured to simultaneous display alternating right view images and left view images in the pixel stripes, forming a 3D image.
